(19) United States
(12) Patent Application Publication
(10) Pub. No.: US 2007/0013537 A1
(43) Pub. Date: Jan. 18, 2007

(54) Vehicle mounted jack system and methods of use

(76) Inventors: Robert S. Jones, University Place, WA (US); Stephanie R. Jones, University Place, WA (US)

Correspondence Address: JAMES RAY & ASSOCIATES, 2640 PITCAIRN ROAD, MONROEVILLE, PA, 15146, US

(21) Appl. No.: 11/487,639

(22) Filed: Jul. 17, 2006

Related U.S. Application Data
(60) Provisional application No. 60/699,991, filed on Jul. 15, 2005.

(51) Int. Cl. G08B 21/00; B60Q 1/00

(52) U.S. Cl. 340/626; 340/438; 340/686.1

(57) ABSTRACT

A vehicle mounted jack system includes a plurality of jacks each disposed adjacent a respective tire of a vehicle and a plurality of mounting brackets for mounting each jack in a vertical position to underside of such vehicle. A control circuits includes a handheld portion having a plurality of switch means each associated with a respective one of the plurality of jacks and manually and selectively operable for generating a first signal to initiate movement of the respective jack into the extended position and a second signal to initiate movement of the respective jack into the retracted position. A drive system, which is responsive to the first and second signal, moves the plurality of jacks between the retracted and the extended position. The system is employable for changing tires, annunciating that a motor vehicle has likely been stolen and for at least monitoring tire pressure.

### CROSS-REFERENCE TO RELATED APPLICATIONS

This application is related to and claims priory from a provisional patent application Ser. No. 60/699,991 filed on Jul. 15, 2005.

### FIELD OF THE INVENTION

The present invention relates, in general, to motor vehicle mounted jack systems and, more particularly, this invention relates to methods of using vehicle mounted jack system for changing tires, leveling vehicle, monitoring and maintaining tire pressure and annunciating that the motor vehicle has likely been stolen.

### BACKGROUND OF THE INVENTION

As is generally well known, changing a tire on a motor vehicle can be both difficult and exhausting for an ordinary person. First, such person must remove a manually operable conventional jack from the storage compartment and carefully position and stabilize it on a ground surface in order to provide for proper lifting of the portion of the vehicle adjacent to the tire to be changed. Difficulties in placement and positioning the jack arise when the jack must be situated on uneven or rough ground surface as the base of the jack is fixed and cannot be pivoted or rotated to compensate for such uneven or rough surface. Furthermore, the ground surface may be covered with snow or ice. Then, the person must exert a manual force to rotate the handle of the jack in order to extend the jack in the vertical direction and lift the portion of the vehicle. After changing the tire, the person must lower the jack, remove it from under the vehicle and replace it in the storage compartment. As it can be seen, a significant effort must be undertaken in addition to the effort of removing old tire and attaching a new or spare tire.

### SUMMARY OF THE INVENTION

According to one embodiment, the invention provides a vehicle mounted tire changing system which includes a plurality of jacks each disposed adjacent a respective tire of a vehicle and which has a predetermined portion thereof movable between a retracted and an extended position. A mounting bracket is provided for mounting the each jack in a vertical position to underside of such vehicle. A control means includes a handheld portion having a plurality of switch means each associated with a respective one of the plurality of jacks. Each switch is manually and selectively operable to generate a first signal in order to initiate a movement of the respective one of the plurality of jacks into the extended position. Each switch is further manually operable to generate a second signal in order to initiate a movement of the respective one of the plurality of jacks into the retracted position. A means is disposed within the handheld portion for wirelessly transmitting a plurality of generated first signals and a plurality of generated second signals therefrom. A drive means is responsive to each of the plurality of first signals and the plurality of second signals to move the respective one of the plurality of jacks between the retracted and the extended position.

According to another embodiment of the invention, therein is provided a method of annunciating that a motor vehicle has likely been stolen. The method includes the step of moving at least a portion of the motor vehicle into a predetermined elevated position above a ground surface. Then, the step of monitoring the elevated position. Next, detecting an unauthorized termination of the elevated position. Finally, activating an alarm means when unauthorized termination of the elevated position was detected.

According to yet another embodiment, the invention provides a method of at least monitoring a tire pressure of a motor vehicle. The method includes the step of mounting a plurality of jacks to underside of the motor vehicle each vertically disposed adjacent a respective one of a plurality of tires of the motor vehicle and movable between a retracted and an extended position. Next, directly connecting the each jack in a fluid communication to the respective one of the plurality of tires. Then, measuring fluid pressure between the each jack and the respective one of the plurality of tires. Finally, comparing measure fluid pressure measure against a predetermined threshold.

According to yet a further embodiment, the invention provides an improved footpad for a jack used in one of a leveling and tire changing system. The footpad includes a heating device for heating the bottom portion of the footpad and an illumination device for illuminating an area around the jack.

### OBJECTS OF THE INVENTION

It is, therefore, one of the primary objects of the present invention to provide a vehicle mounted jack system.

Another object of the present invention is to provide a vehicle mounted jack system that enables the person to conveniently change tires.

Yet another object of the present invention is to provide a vehicle mounted jack system which is suitable for use with hydraulic, pneumatic and electrical jacks.

A further object of the present invention is to provide a vehicle mounted jack system that employs a handheld controller for operating a plurality of vehicle mounted jacks.

Yet a further object of the present invention is to provide a hydraulic or pneumatic vehicle mounted jack system which is capable of measuring and annunciating fluid pressure.

An additional object of the present invention is to provide a vehicle mounted jack system that employs microprocessor based controls.

Another object of the present invention is to provide a vehicle mounted jack system that is employed for annunciating that a motor vehicle has likely been stolen.

Yet another object of the present invention is to provide a vehicle mounted jack system that is employed for at least measuring tire pressure.

Still another object of the present invention is to provide a vehicle mounted jack system wherein each jack is directly connected to a respective tire.

A further object of the present invention is to provide an improved footpad for a vehicle mounted jack which is employed for leveling the vehicle or changing tires.

Yet a further object of the present invention is to provide an improved footpad for a vehicle mounted jack that is heated.

Still a further object of the present invention is to provide an improved footpad for a vehicle mounted jack that illuminates area around the jack.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is an elevation view of a vehicle mounted jack system of the present invention;

FIG. 2 is an elevation view of the vehicle mounted jack system of FIG. 1, particularly illustrating attachment of each jack to the underside of the vehicle;

FIG. 3 is a schematic diagram of the vehicle mounted jack system of FIG. 1;

FIG. 4 is a planar view of a handheld controller for operating the plurality of jacks according to one embodiment of the invention;

FIG. 5 is a planar view of a handheld controller for operating the plurality of jacks according to another embodiment of the invention;

FIG. 6 is a planar view of the controller for operating the plurality of jacks according to yet another embodiment of the invention which is mounted within a dashboard of the vehicle;

FIG. 7 is an elevation view of the vehicle mounted jack system of the present invention, particularly illustrating a presently preferred footpad connected to a distal end of each jack;

FIG. 8 is a schematic diagram of a control system for operating heating and illuminating devices mounted within the footpad of FIG. 7.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

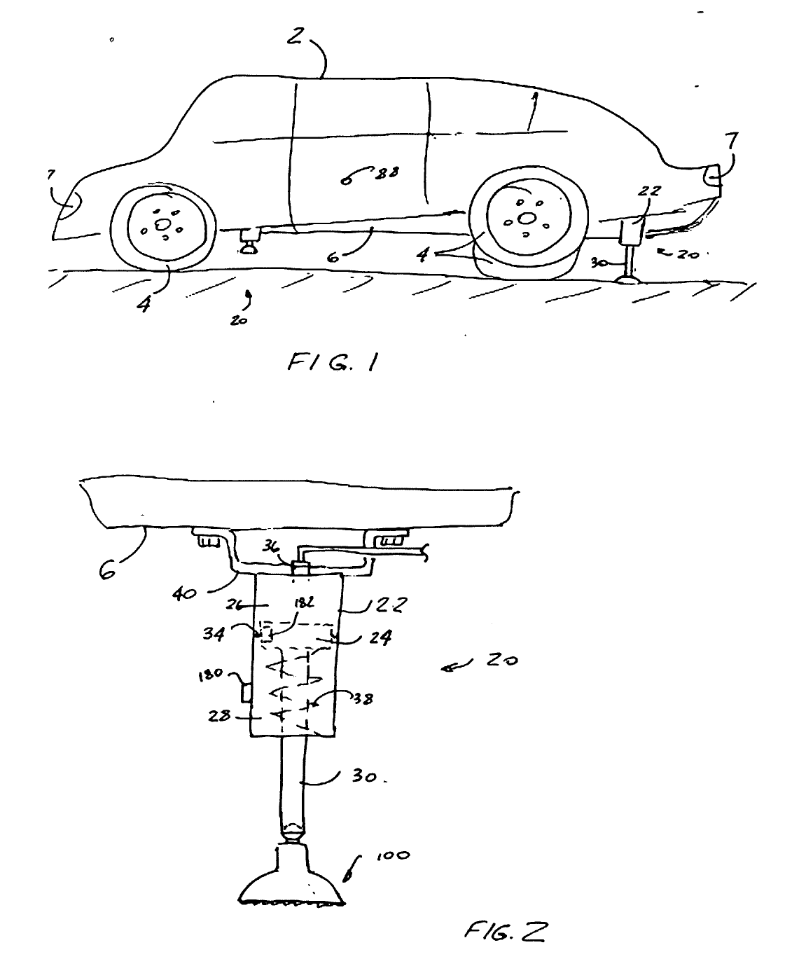

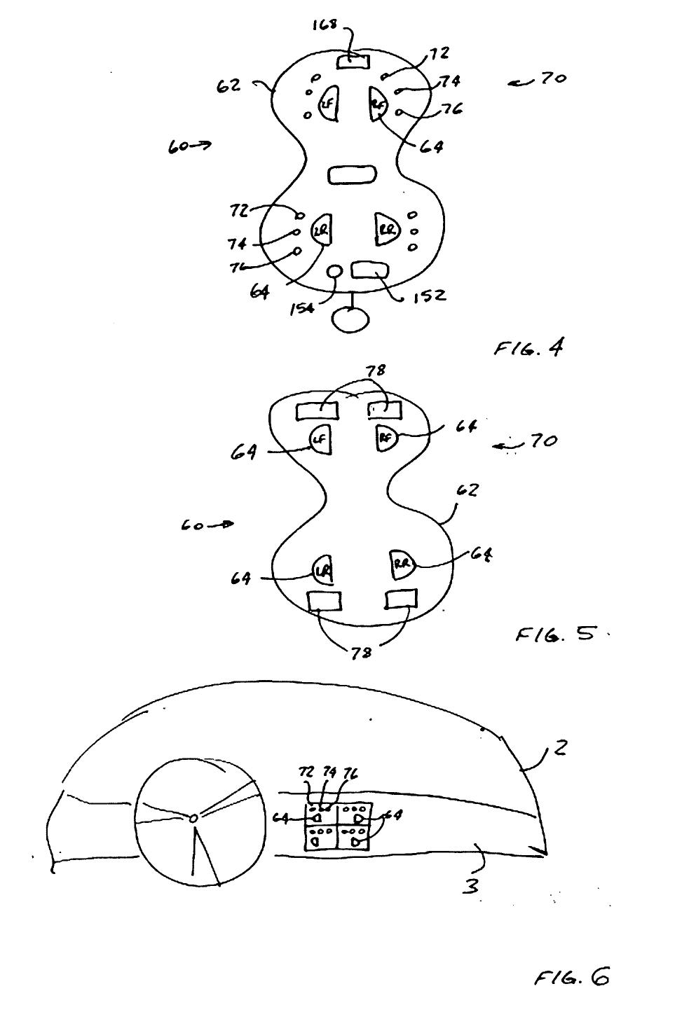

According to a first embodiment of the invention, there is provided a vehicle mounted tire changing system, generally designated as 10. In reference to FIGS. 1-6, the system 10 includes a plurality of jacks, generally designated as 20, each disposed adjacent a respective tire 4 of a vehicle 2 and having a predetermined portion movable between a retracted and an extended position.

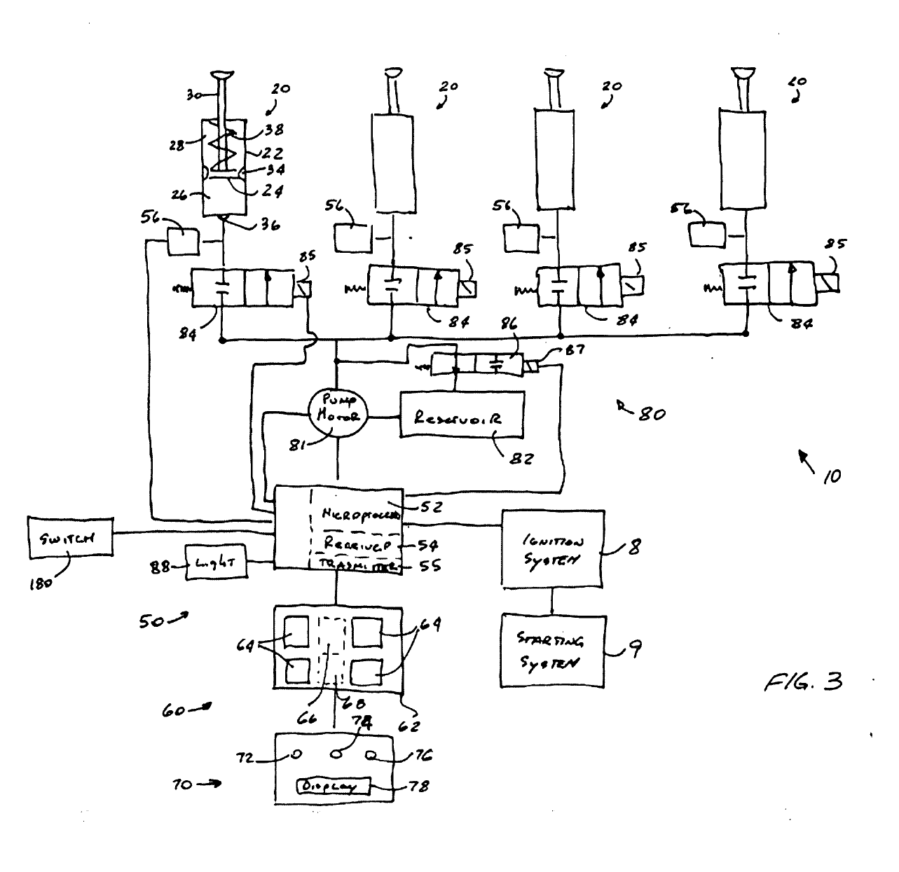

In the presently preferred embodiment of the invention, best shown in FIGS. 2-3, each jack 20 is a hydraulically operable cylinder and includes a housing 22, a piston 24 which is mounted for a linear movement within the housing 22 and which forms a first chamber 26 and a second chamber 28. A rod 30 is axially attached to the piston 24 for a movement therewith and for a further movement between the retracted and the extended position. A seal means 34 is attached to a peripheral edge of the piston 24 for sealingly engaging the inner surface of the housing 22 and for sealing the first chamber 26 from the second chamber 28. A fluid communication means 36, such as an inlet port 36, is provided in fluid communication with the first chamber 26 and with a source of hydraulic fluid pressure 82 for selectively supplying fluid pressure to the first chamber 26 during movement of the rod 30 into the extended position and evacuating the fluid pressure from the first chamber 26 during movement of the rod 30 into the retracted position. A compression spring means 38 is preferably axially mounted within the second chamber 28 for moving the rod 30 into the retracted position. Alternatively, the spring means 38 may be mounted external to the housing 22.

A mounting means, such as a simple bracket 40 is attached to the housing 20 adjacent the first chamber 26 and is attached to the underside 6 of the motor vehicle 2 for mounting each jack 20 in a vertical position.

A footpad, generally designated as 100, is attached to a distal end of each rod 30 for spreading the force generated by the rod 30 over a larger portion of the ground surface.

The system 10 further includes a control means, generally designated as 50, which includes a handheld controller, generally designated as 60, best shown in FIGS. 3-5, for operating the plurality of jacks 20. The controller 60 includes a housing 62 having each of a predetermined shape and a predetermined size. A plurality of switch means 64 is manually operable from an exterior surface of the housing 62. Each switch means 64 is associated with a respective one of the plurality of jacks 20 and is selectively operable for generating a first signal to initiate movement of the respective one of the plurality of jacks 20 into the extended position and a second signal to initiate movement of the respective one of the plurality of jacks 20 into the retracted position. A transmitter means 66 is disposed within the housing 62 for wirelessly transmitting a plurality of generated first signals and a plurality of generated second signals therefrom. Such plurality of generated first signals and plurality of generated second signals are received by a receiver means 54 coupled to a processing means 52 which is stationary mounted in a predetermined location within such motor vehicle 2.

The system 10 additionally includes a drive means, generally designated as 80, which is responsive to each of the plurality of first signals and the plurality of second signals to move the respective one of the plurality of jacks 20 between the retracted and the extended position. When the jack 20 is a hydraulically operated cylinder, the drive means 80 preferably includes such source of hydraulic fluid pressure 82, a pump motor 81 and a plurality of solenoid actuated valves 84 which are mounted in fluid communication with the source of hydraulic fluid pressure 82 and with each jack 20. Alternatively, the source of hydraulic fluid pressure is mounted within the vehicle 2 for use with a brake system (not shown).

In operation, to change one of the plurality of tires 4, the user uses the handheld controller 60 and, more particularly, a respective switch means 64 to generate a first signal which is transmitted by the transmitter means 66 and is received by the receiver means 54. In response to the received first signal, the processing means 52 energizes the coil 85 of the solenoid valve 84 to allow supply of the fluid pressure to the first chamber 26 thus causing the rod 64 to move into the extended position and elevate the respective portion of the vehicle 2.

When the user completed tire change, the user generates a second signal which is transmitted by the transmitter 66 and received by the receiver 54. The processing means 52 denergizes the coil 85 of the solenoid 84 to discontinue supply of the fluid pressure and deenergizes a coil 87 of the evacuation valve 86 to evacuate fluid pressure from the first chamber 26 and return it to the source of fluid pressure 82. It will be appreciated that the coil 87 of the evacuation valve 87 is energized by the microprocessing means 52 just prior to the coil 85 being energized. With the fluid pressure evacuated from the first chamber 26, the spring means 38 moves the rod 32 into the retracted position thus enabling normal operation of the vehicle 2.

The control means 50 is preferably coupled with the ignition system 8 of the vehicle 2 and the microprocessing means 52 may be programmed to flash vehicle lights 7 prior to movement of the jack 20 into at least one of the extended and the retracted position. Alternatively, a light 88 may be attached to each side of such vehicle 2 and operable by the control means 50 at least prior to movement of the jack 20 into at least one of the extended and the retracted position.

Advantageously, the microprocessing means 52 is programmed to respond to the received first signal only when the ignition system 8 is enabled but the starting system 9 is disabled. Accordingly, the user will be assured that the vehicle 2 will not accidentally move when one of the jacks 20 is in the extended position. The processing means 52 may be further programmed to disregard a second first signal being transmitted from the handheld controller 60 when one of the jacks 20 is already in the extended position.

Additionally, the processing means 52 may be programmed to partially extend and then retract the plurality of jacks 20 when the ignition system 8 of such vehicle 2 is activated in order to test proper operation of the system 10.

The system 10 may further include a pressure sensor 56 in combination with each jack 20 which is responsive to a fluid pressure within the each jack 20 and operable to provide an indication signal to the control means 50 of whether the fluid pressure in the each jack 20 is above or below a predetermined pressure threshold. The control means 50 will be then further adapted with an annunciation means, generally designated as 70 to annunciate such indication signal.

According to one embodiment of the invention, such annunciation means may include a plurality of first indicators 72 to indicate that the pressure within a respective jack 20 is equal or greater than the predetermined pressure threshold and a plurality of second indicators 74 to indicate that the pressure within a respective jack 20 is less than the predetermined pressure threshold. Furthermore, a third indicator 76 may be provided to indicate when the fluid pressure is substantially equal to zero. Advantageously, such first, second and third indicators 72, 74 and 76 respectively are mounted within the handheld controller 60. To communicate such indication to controller 60 and operate indicators 72, 74, and 76, the controller 60 is provided with a receiver 68 and the control means 50 is adapted with a transmitter 55. It will be appreciated that the receiver 54 and the transmitter 55 may be combined into what is well known as a transceiver. Alternatively, or in addition to being mounted within the handheld controller 60, these indicators may be mounted within dashboard 3 of the vehicle 2.

Yet alternatively, a single digital display 78 or a plurality of digital displays 78 may be provided to indicate actual measured value of the fluid pressure within each jack 20.

Although the present invention has been shown in terms of the hydraulically operated jack 20, it will be apparent to those skilled in the art, that the present invention according to the above described embodiments may be applied to pneumatically operated jacks. Furthermore, an electrically operated screw jack may be utilized in the present invention by replacing the drive means 80 with a plurality of electric motors coupled to a source of electric energy, such as a battery.

The drive system 50 may utilize a pair of solenoids 84 in combination with each jack 20, wherein the second solenoid is connected to the second chamber 28 and is operable by the control means 50 upon receipt of the second signal to supply fluid pressure into the second chamber 28 and move the rod 30 into the retracted position. Other well known drive system arrangements may be used in the present invention. For example, U.S. Pat. No. 5,188,379 issued on Feb. 23, 1993 to Krause et al teaches a control valve assembly which a plurality of solenoid valves integrated thereinto. U.S. Pat. No. 4,597,584 issued on Jul. 1, 1986 to Hanser discloses a cylinder member employed in combination with each jack for pivoting the jack between horizontal and vertical positions. Teachings of U.S. Pat. No. 5,188,379 and U.S. Pat. No. 4,597,584 are incorporated into this document by reference thereto.

Additionally, a telescopic type jack as disclosed in U.S. Pat. No. 6,079,742 issued on Jun. 27, 2000 to Spence may be utilized in the present invention. The teaching of U.S. Pat. No. 6,079,742 is incorporated into this document by reference thereto.

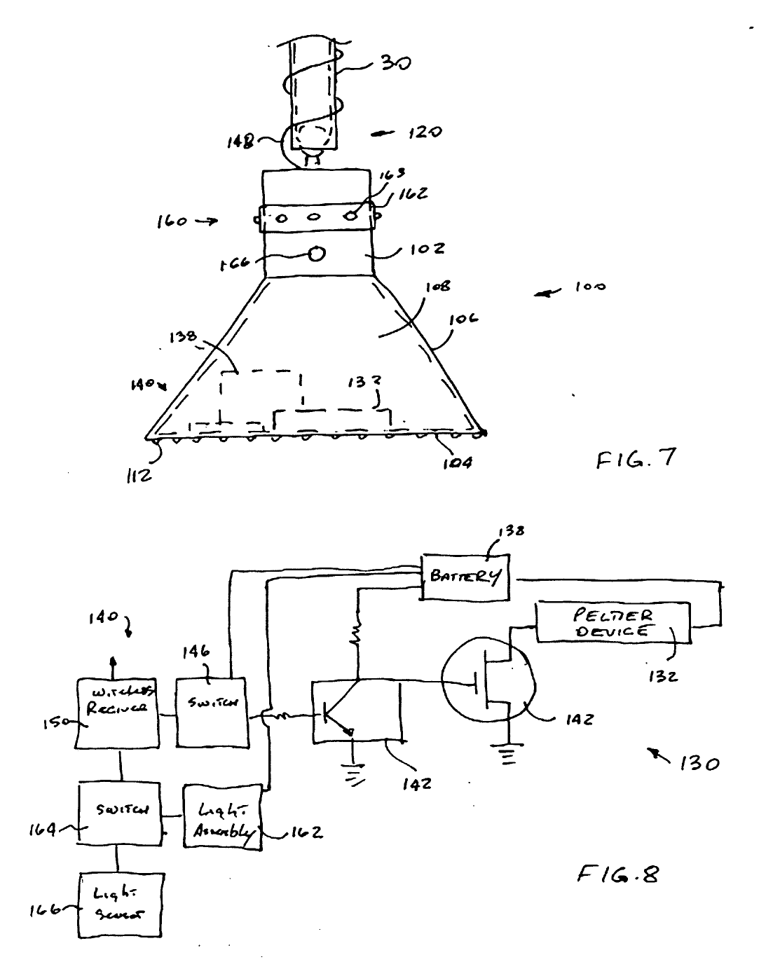

According to another embodiment, the invention provides a novel footpad 100 for use in combination with a jack 20 of the above described embodiments. Now in reference to FIGS. 7-8, the footpad 100 includes a base portion 102, a foot portion 104 which has a predetermined size and a peripheral surface portion 106 which connects the foot portion 104 to the base portion 102 and which is conically shaped to form an internal chamber 108.

The bottom surface of the foot portion 104 has an anti-slip means attached thereto, which may be simply formed by a plurality of projections or ribs 112 extending outwardly from the bottom surface of the foot portion 104.

To improve stability of the footpad 100 and, more particularly, of the jack 20, a pivot means, generally designated as 120, is provided for connecting the base portion 102 to the distal end of the rod 30 of the jack 20. Preferably, such pivot means 120 is a swivel means 120 of any well known swivel constructions.

The invention contemplates that the footpad 100 may be heated in situations wherein the ground surface is covered with snow or ice. Accordingly, the footpad 100 includes a heating means, generally designated as 130 for heating at least the foot portion 104 to a predetermined temperature in response to a signal received from the control means 50. Furthermore, at least the foot portion 104 will be formed form a heat conductive material, preferably a metal.

The heating means 130 may simply include at least one predetermined solid-state device 132 and a control circuit, generally designated as 140, which is connected to the predetermined solid-state device 132 and to a source of power 138 for controlling operation of the at least one predetermined solid-state device 132. Such at least one predetermined solid-state device 132 is preferably from a family of solid-state devices commonly known as thermoelectric modules and, more particularly, the predetermined solid-state device is a well known Peltier Device which has a hot side abutting the upper surface of the foot portion 104.

Now in a particular reference to FIG. 8, the control circuit 140 may simply include a transistor 142 which is connected to the source of power 138, a MOSFET power transistor 144 and a switch means 146 which is responsive to the control signal received from the control means 50 to selectively activate or deactivate the Peltier Device 132. The connection between the switch means 146 and the control means 50 may be achieved with a wire cable 148 which also includes a coiled portion 149 to accommodate extension and retraction of the rod 30 and preferably, the connection between the switch means 146 and the control means 50 is achieved in a wireless manner by coupling a receiver means 150 to the switch means 146. It will be appreciated that the receiver means 150 and the switch means 146 may be a solid-sate or a microprocessor based devices. Accordingly, the handheld controller 60 will include a switch means 152 to control operation of the heating means 130 and a light indicator 154 which illuminates when the heating means 130 has been activated.

It is further presently preferred that the power source 138, such as a battery is also provided and mounted within the internal chamber 108. The inclusion of the battery 138 eliminates the need to rout electrical wires through the vehicle 2 and reduces installation costs.

Although, the present invention has been shown in terms of the heating means 130 employing a Peltier Device, it will be apparent to those skilled in the art, that the other devices capable of generating heat may be used in the present invention.

According to yet another embodiment of the invention, therein is provided an illumination means, generally designated as 160 which is attached to the footpad 100 for illuminating an area around the jack 20 and aiding in changing the tire 2 during darkness or nightfall.

In the presently preferred embodiment of the invention, such illumination means 160 includes a light assembly 162 attached to the base portion 102 of the footpad 102 which, for example, employs a plurality of light emitting diodes (LEDs) 163 and a switch means 164 to operate such light assembly 162. Preferably, a light sensor 166 is installed in the base portion 102 which is responsive to a light intensity of a surrounding environment to activate the switch means 164 in combination with extended jack 20. Alternatively, a switch 168 may be provided within the handheld controller 60 for remotely activating the switch means 164 and the light assembly 162 through the control means 50. Connecting the light assembly 162 to the power source 138 also provides for wireless operation of the illumination means 160 installed in the vehicle 2.

According to a further embodiment, the present invention provides a novel method of annunciating that a motor vehicle 2 has likely been stolen. The method includes the steps of moving at least a portion of the motor vehicle 2 into a predetermined elevated position above a ground surface. Then, monitoring the elevated position. Next, detecting an unauthorized termination of the elevated position. Finally, activating an alarm means when unauthorized termination of the elevated position was detected. Advantageously, the at least portion of the motor vehicle 2 is moved into the elevated position by a jack 20 of the above described embodiments which is mounted vertically and adjacent one of a plurality of tire 4 of the motor vehicle 2 and which is movable between a retracted and an extended position. The elevated position is monitored by a switch 180 which is activated when the jack 20 is moved into the extended position to move the at least portion of the motor vehicle 2 is moved into the elevated position and by the control means 50 coupled to the switch 180 and responsive to the switch 180 being activated. By way of example in FIG. 2, the switch 180 is attached in a predetermined location to the exterior surface of the housing 22 for sensing the target 184 mounted within the piston 24. When the target 184 is aligned with the switch 182, the later generates a signal which is received by the control means 50 to indicate that the jack 20 is in extended position.

In operation, the owner or an authorized user of the vehicle 2 extends at least one jack 20 when the vehicle 2 is in a stationary position and when the ignition system 8 is deactivated. The control means 50 receives the signal from the switch 182 and is programmed to detect unauthorized termination of the elevated position when the signal is terminated due to loss of alignment between the target 184 and the switch 182. The loss of alignment will be caused by the respective tire 4 engaging the ground surface when the vehicle 2 is moving. The control means 50 is programmed to activate a vehicle alarm (not shown) in response to the switch 182 being deactivated. The control means 50 may be further programmed to wirelessly transmit a predetermined signal to a remotely disposed device, such as a mobile phone or any other wireless portable communication device owned by the owner or the authorized user of the vehicle 2 or such as a network computer of the law enforcement or vehicle tracking agency.

It would be apparent to those skilled in the art that the monitoring of the fluid pressure may be also employed to detect unauthorized termination of the elevated position. Furthermore, the owner may elect to extend the plurality of jack 20 to elevate the entire vehicle 2 above the ground surface. Advantageously, the underside 6 of the vehicle 2 may be elevated into a position wherein the tires 4 visually touch the ground surface.

According to yet a further embodiment of the invention therein is provided a novel method of at least monitoring a tire pressure of a motor vehicle 2. The method includes the steps of mounting a plurality of jacks 20 to underside 6 of the motor vehicle 2 each vertically disposed adjacent a respective tire 2 of the vehicle 2 and movable between a retracted and an extended position. Then, directly connecting each jack 20 and, more particularly, the first chamber 26 thereof, in a fluid communication to a respective one of a plurality of tires 4. Next, using the control means 50 and the pressure sensor 56 to measure fluid pressure between the each jack 20 and the respective one of the plurality of tires 2. Finally, comparing the measured fluid pressure against a predetermined threshold. The control means 50 is programmed to decrease or increase the fluid pressure in a respective tire 4 based on the measured fluid pressure value.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A vehicle mounted tire changing system, said system comprising:
(a) a plurality of jacks each disposed adjacent a respective tire of a vehicle and having a predetermined portion movable between a retracted and an extended position;
(b) a mounting means for mounting said each jack in a vertical position to underside of such vehicle;
(c) a control means including a handheld portion having a plurality of switch means each associated with a respective one of said plurality of jacks and manually and selectively operable for generating a first signal to initiate a movement of said respective one of said plurality of jacks into said extended position and a second signal to initiate a movement of said respective one of said plurality of jacks into said retracted position and means disposed within said handheld portion for wirelessly transmitting a plurality of generated first signals and a plurality of generated second signals therefrom; and
(d) a drive means responsive to each of said plurality of first signals and said plurality of second signals to move said respective one of said plurality of jacks between said retracted and said extended position.

2. The system, according to claim 1, wherein said system further includes a plurality of footpads each attached to a respective one of said plurality of jacks.

3. The system, according to claim 1, wherein said each jack includes a pressure sensor responsive to a fluid pressure within said each jack and operable to provide an indication of whether said fluid pressure in said each jack is above or below a predetermined pressure threshold.

4. The system, according to claim 1, wherein said control means includes an annunciation means to annunciate said indication.

5. The system, according to claim 1, wherein said plurality of jacks are hydraulic jacks and said drive system includes a source of a hydraulic fluid pressure, a motor pump and a plurality of solenoid actuated valves mounted in fluid communication with said source of hydraulic fluid pressure.

6. The system, according to claim 1, wherein said control means is programmed to partially activate said plurality of jacks when an ignition system of such vehicle is activated.

7. The system, according to claim 1, wherein said mounting means includes a bracket means which is attached to one end of said each jack and which is attached to such underside of such vehicle.

8. The system, according to claim 1, wherein such vehicle includes a pair of lights each attached to a respective side of such vehicle and operable by said control means at least prior to movement of said jack into one of said extended and said retracted position.

9. In combination with one of a leveling and tire changing system for a motor vehicle including a plurality of jacks vertically mounted to an underside of such vehicle and operable between extended and a retracted position; the improvement comprising a heating means for heating a footpad attached to a lowermost end of said jack to a predetermined temperature in response to a signal received from said control means.

10. The system, according to claim 9, wherein said heating means includes at least one predetermined solid-state device and a control circuit connected to said predetermined solid-state device and to a source of power for controlling operation of said predetermined solid-state device.

11. The system, according to claim 9, wherein said system further includes said power source.

12. In combination with one of a leveling and tire changing system for a motor vehicle including a plurality of jacks vertically mounted to an underside of such vehicle and operable between extended and a retracted position; the improvement comprising an illumination means attached to each jack in close proximity to a lowermost end thereof.

13. The system, according to claim 12, wherein said system includes a sensor responsive to a light intensity of a surrounding environment to operate said illuminating means in combination with operation of said each jack.

14. A method of annunciating that a motor vehicle has likely been stolen, said method comprising the steps of:
(a) moving at least a portion of said motor vehicle into a predetermined elevated position above a ground surface;
(b) monitoring said elevated position;
(c) detecting an unauthorized termination of said elevated position; and
(d) activating an alarm means when unauthorized termination of said elevated position was detected in step (c).

15. The method, according to claim 14, wherein said at least portion of said motor vehicle is moved into said elevated position by a jack mounted vertically and adjacent one of a plurality of tires of said motor vehicle, said jack movable between a retracted and an extended position.

16. The method, according to claim 15, wherein said elevated position is monitored by a switch which is activated when said jack is moved into said extended position to move said at least portion of said motor vehicle is moved into said elevated position and by a control means coupled to said switch and responsive to said switch being activated.

17. The method, according to claim 16, wherein said unauthorized termination of said elevated position is detected in step (c) when said switch is deactivated.

18. The method, according to claim 16, wherein said control means wirelessly transmits a predetermined signal to a remotely disposed device.

19. A method of at least monitoring a tire pressure of a motor vehicle, said method comprising the steps of:
(a) mounting a plurality of jacks to underside of said motor vehicle each vertically disposed adjacent a respective one of a plurality of tires of said motor vehicle and movable between a retracted and an extended position;
(b) directly connecting said each jack in a fluid communication to said respective one of said plurality of tires;
(c) measuring fluid pressure between said each jack and said respective one of said plurality of tires; and
(d) comparing said fluid pressure measure in step (c) against a predetermined threshold.

20. The method, according to claim 19, wherein said method further includes a step of decreasing or increasing said fluid pressure compared in step (d).
